(19) United States
(12) Patent Application Publication
(10) Pub. No.: US 2025/0296421 A1
(43) Pub. Date: Sep. 25, 2025

(54) LOWER VEHICLE-BODY STRUCTURE OF VEHICLE

(71) Applicant: MAZDA MOTOR CORPORATION, Hiroshima (JP)

(72) Inventors: Eiji KAMEMOTO, Hiroshima (JP); Taiki YOTSUYANAGI, Hiroshima (JP); Tatsuya ISHIKAWA, Hiroshima (JP); Yoshikazu NISHIMURA, Hiroshima (JP); Kuniyoshi TASHIRO, Hiroshima (JP); Masayuki MIYAZAKI, Hiroshima (JP); Taiga MICHIMOTO, Hiroshima (JP)

(73) Assignee: MAZDA MOTOR CORPORATION, Hiroshima (JP)

(21) Appl. No.: 19/046,677

(22) Filed: Feb. 6, 2025

(30) Foreign Application Priority Data
Mar. 25, 2024 (JP) 2024-048552

(51) Int. Cl. B60K 1/04; B60L 50/60; B60N 2/005; B62D 25/20; H01M 50/242; H01M 50/249; H01M 50/271

(52) U.S. Cl. CPC B60K 1/04; B60L 50/66; B60N 2/005; B62D 25/20; H01M 50/242; H01M 50/249; H01M 50/271; B60K 2001/0438; H01M 2220/20

(57) ABSTRACT

A lower vehicle-body structure of a vehicle ensures safety when a collision load is input and ensures a high degree of freedom in design relating to the arrangement of seats in a vehicle cabin. A vehicle includes a floor panel, a seat, a battery disposed below the floor panel, and battery outer cross members extending in the vehicle width direction in a space between the floor panel and a battery housing. The battery housing includes inner members that extend in the front-rear direction at a position below a lid body and connect opposing outer peripheral walls of a housing body portion. The battery outer cross members are fixed to the inner members with the lid body interposed between the battery outer cross members and the inner members, and fixed to seat rails with the floor panel interposed between the battery outer cross members and the seat rails.

### TECHNICAL FIELD

The present disclosure relates to a lower vehicle-body structure of a vehicle, and particularly to a lower vehicle-body structure of a vehicle in which a battery is disposed below a floor panel.

### BACKGROUND

In recent years, battery electric vehicles (BEV), hybrid electric vehicles (HEV), and other electric vehicles have been rapidly becoming popular. In such electric vehicles, a large-sized battery is mounted below a floor panel. Japanese Patent Laid-Open No. 2021-59141 discloses a vehicle in which seat frames are fixed to a housing of a battery mounted below a floor panel.

The vehicle disclosed in Japanese Patent Laid-Open No. 2021-59141 includes vehicle-body-side cross members and battery-side cross members, the vehicle-body-side cross members connecting side sills with a center tunnel in the vehicle width direction on the floor panel, the battery-side cross members being provided on the lower side of the lid body of a battery housing, and extending in the vehicle width direction. Of the seat frames, each inner seat frame located on the vehicle-width-direction inner side is fixed to the center tunnel, and is fixed to the vehicle-body-side cross members by fastening using bolts. Each outer seat frame located on the vehicle-width-direction outer side is fixed to the side sill, and is fixed to the vehicle-body-side cross members by fastening using the bolts.

The battery-side cross members are fixed to the inner and outer seat frames by fastening using the bolts.

### SUMMARY

It is considered difficult for the above-mentioned vehicle disclosed in Japanese Patent Laid-Open No. 2021-59141 to both ensure safety when a collision load is input and ensure the degree of freedom in design relating to arrangement of seats in a vehicle cabin. Specifically, in the above-mentioned vehicle disclosed in Japanese Patent Laid-Open No. 2021-59141, at intersecting parts between the inner and outer seat frames and the vehicle-body-side cross members, the top plate parts of the seat frames are disposed in such a way as to cover the vehicle-body-side cross frames from above. In addition, each inner seat frame is fixed to the center tunnel, and each outer seat frame is fixed to the side sill. Therefore, when attempting to ensure a certain height of the vehicle-body-side cross members in order to ensure safety at the time of inputting of a collision load, the height position of the seat frames is increased.

As described above, it is considered difficult for the above-mentioned vehicle disclosed in Japanese Patent Laid-Open No. 2021-59141 to set the seat frames at a low position while ensuring the height of the vehicle-body-side cross members which is required to ensure safety.

It is also considered that the positions of the seat frames in the vehicle width direction have a low degree of freedom in design due to the relationship with the center tunnel and the side sills. That is, in the case in which the seat frames are caused to be distant from the center tunnel or the side sills, there is no choice but to have a large distance between the seat frames in the vehicle width direction and hence, it is considered that the seats attached to the seat frames may have a problem from the viewpoint of stability.

The present disclosure has been made to solve the above-mentioned problem, by providing a lower vehicle-body structure of a vehicle that can both ensure safety when a collision load is input, and ensure a high degree of freedom in design relating to arrangement of seats in a vehicle cabin.

A lower vehicle-body structure of a vehicle according to one aspect of the present disclosure includes: a floor panel that constitutes a floor of a vehicle cabin of the vehicle; a vehicle seat that includes a seat rail disposed on the floor panel; an outer skeleton portion that is formed to extend in a first direction, and that is disposed below the floor panel, the first direction being either one of a front-rear direction of the vehicle or a vehicle width direction; and a battery that includes a battery cell and a battery housing accommodating the battery cell, and that is disposed below the outer skeleton portion.

In the lower vehicle-body structure of a vehicle according to the above-mentioned aspect, the battery housing includes a housing body portion, a lid portion, and an inner skeleton portion, the housing body portion being a casing that includes an outer peripheral wall and that has an opening on an upper side of the casing, the lid portion closing the opening of the housing body portion, the inner skeleton portion extending in a second direction in the housing body portion, and being formed in such a way as to connect opposing portions of the outer peripheral wall, the second direction intersecting with both an up-down direction of the vehicle and the first direction, and the outer skeleton portion is fixed to the inner skeleton portion with the lid portion interposed between the outer skeleton portion and the inner skeleton portion, and is fixed to the seat rail with the floor panel interposed between the outer skeleton portion and the seat rail.

In the lower vehicle-body structure of a vehicle according to the above-mentioned aspect, the outer skeleton portion is disposed between the floor panel and the battery housing, that is, below the floor panel. Accordingly, also in a case in which the height of the outer skeleton portion in cross section is defined in order to ensure rigidity of the vehicle body, there is no possibility of affecting the height position of the seat rail (the height position of the vehicle seat) with respect to the floor panel.

In the lower vehicle-body structure of a vehicle according to the above-mentioned aspect, the seat rail is fixed to the battery housing via the outer skeleton portion. The battery housing is formed to have high rigidity for the purpose of protecting the battery cell, which is housed in the battery housing, from a collision load or the like. Accordingly, in the lower vehicle-body structure of a vehicle according to the above-mentioned aspect, the seat rail is fixed to the battery housing having high rigidity and hence, undesired vibrations or the like of the vehicle seat can be prevented. Therefore, it is possible to achieve excellent riding comfort of the vehicle seat.

In the lower vehicle-body structure of a vehicle according to the above-mentioned aspect, the outer skeleton portion may be integrally formed with the lid portion of the battery housing, or may be formed as a separate body from the lid portion. In the lower vehicle-body structure of a vehicle according to the above-mentioned aspect, the inner skeleton portion may be integrally formed with the housing body portion, or may be formed as a separate body from the housing body portion.

The lower vehicle-body structure of a vehicle according to the above-mentioned aspect may further include a second outer skeleton portion, assuming the outer skeleton portion as a first outer skeleton portion, the second outer skeleton portion being an outer skeleton portion that is disposed between the floor panel and the battery housing, and that is different from the first outer skeleton portion, the second outer skeleton portion extending in the first direction, and being disposed with a distance from the first outer skeleton portion in the second direction, assuming the inner skeleton portion as a first inner skeleton portion, the battery housing may further include a second inner skeleton portion that is disposed in the housing body portion, that extends in the second direction, that is distant from the first inner skeleton portion in the first direction, and that is formed in such a way as to connect the opposing portions of the outer peripheral wall of the housing body portion, the second inner skeleton portion may be fixed to the first outer skeleton portion and the second outer skeleton portion with the lid portion interposed between the second inner skeleton portion and the first outer skeleton portion, and with the lid portion interposed between the second inner skeleton portion and the second outer skeleton portion, and the second outer skeleton portion may be fixed to the first inner skeleton portion with the lid portion interposed between the second outer skeleton portion and the first inner skeleton portion, and may be fixed to the seat rail with the floor panel interposed between the second outer skeleton portion and the seat rail.

The lower vehicle-body structure of a vehicle according to the above-mentioned aspect further includes the second outer skeleton portion, and the battery housing further includes the second inner skeleton member. The first inner skeleton portion and the second inner skeleton portion are fixed to the first outer skeleton portion and the second outer skeleton portion. The first outer skeleton portion is spaced apart from the second outer skeleton portion in the second direction, and the first inner skeleton portion is spaced apart from the second inner skeleton portion in the first direction. Due to such a configuration, in the lower vehicle-body structure of a vehicle according to the above-mentioned aspect, the first outer skeleton portion and the second outer skeleton portion, and the first inner skeleton portion and the second inner skeleton portion of the battery housing constitute a rectangular lattice structure portion when viewed in a plan view from one direction along the up-down direction. Therefore, high rigidity can be ensured under the floor panel and hence, it is possible to ensure high safety in a collision (in a front collision, in a side collision) of a vehicle.

In addition, the seat rail is fixed to the first outer skeleton portion and the second outer skeleton portion. This means that the seat rail is fixed to the above-mentioned rectangular lattice structure portion having high rigidity. Therefore, in the above-mentioned lower vehicle-body structure of a vehicle, undesired vibrations or the like of the vehicle seat are prevented and hence, it is possible to achieve excellent riding comfort of the vehicle seat.

In the lower vehicle-body structure of a vehicle according to the above-mentioned aspect, the outer skeleton portion may be a separate body from the lid portion of the battery housing, and may be directly placed on the lid portion.

In the lower vehicle-body structure of a vehicle according to the above-mentioned aspect, the outer skeleton portion is directly placed on the lid portion of the battery housing, that is, the outer skeleton portion is directly placed on the lid portion configured to expand in directions intersecting with the up-down direction and hence, a load input to the outer skeleton portion in a collision or the like of the vehicle is also dispersed to the lid portion. Therefore, the above-mentioned lower vehicle-body structure of a vehicle has an advantage in ensuring even higher rigidity of the vehicle body.

In the lower vehicle-body structure of a vehicle according to the above-mentioned aspect, the outer skeleton portion is a separate body from the lid portion and hence, it is possible to define the position of the outer skeleton portion relative to the lid portion depending on the layout of the vehicle. Therefore, the lid portion and the outer skeleton portion can be used in common for a plurality of vehicle types and hence, it is possible to achieve a reduction in manufacturing costs.

In the lower vehicle-body structure of a vehicle according to the above-mentioned aspect, the seat rail may be directly placed on the floor panel.

In the lower vehicle-body structure of a vehicle according to the above-mentioned aspect, the seat rail is directly placed on the floor panel. This means that the floor panel is directly interposed between the seat rail and the outer skeleton portion. Therefore, the floor panel is fixed to the outer skeleton portion and the inner skeleton portion which are fixed to each other and hence, membrane vibration of the floor panel is suppressed.

In the lower vehicle-body structure of a vehicle according to the above-mentioned aspect, the first direction may be the vehicle width direction, and the second direction may be the front-rear direction.

The lower vehicle-body structure of a vehicle according to the above-mentioned aspect is configured by assuming the vehicle width direction as the first direction, and the front-rear direction as the second direction. Thus, in a side collision, the outer skeleton portion, in cooperation with the inner skeleton portion, can resist against a collision load input to the outer skeleton portion and, in a front collision, the inner skeleton portion, in cooperation with the outer skeleton portion, can resist against a collision load input to the inner skeleton portion. Therefore, the lower vehicle-body structure of a vehicle according to the above-mentioned aspect can ensure high safety in both of a front collision and a side collision.

In the lower vehicle-body structure of a vehicle according to the above-mentioned aspect, the outer peripheral wall of the housing body portion may be disposed in such a way as to be in contact with or proximate to side sills in the first direction, the side sills being disposed on both sides in the vehicle width direction.

In the lower vehicle-body structure of a vehicle according to the above-mentioned aspect, the outer peripheral wall of the housing body portion of the battery housing is disposed in such a way as to be in contact with or proximate to the side sill and hence, a collision load input to the side sill in a side collision is dispersed to the inner skeleton portion and the outer skeleton portion via the outer peripheral wall of the battery housing. Therefore, the lower vehicle-body structure of a vehicle according to the above-mentioned aspect has an advantage in ensuring high safety in a side collision.

In the lower vehicle-body structure of a vehicle according to the above-mentioned aspect, the outer peripheral wall may include an outwardly-projecting portion that is in contact with or proximate to a lower surface of the side sill.

In the lower vehicle-body structure of a vehicle according to the above-mentioned aspect, the outer peripheral wall of the housing body portion of the battery housing includes the outwardly-projecting portion, and the outwardly-projecting portion is disposed in such a way as to be in contact with or proximate to the lower surface of the side sill and hence, it is possible to suppress vertical movement of the battery during traveling or other movement of the vehicle. In the lower vehicle-body structure of a vehicle according to the above-mentioned aspect, vertical movement of the battery can be suppressed during traveling or other movement of the vehicle and hence, it is possible to suppress membrane vibration of the floor panel which is fixed to the battery housing via the outer skeleton portion. Accordingly, the vehicle according to the above-mentioned aspect can suppress vibrations in the vehicle cabin, thus ensuring high comfort of the occupant.

In the lower vehicle-body structure of a vehicle according to the above-mentioned aspect, the inner skeleton portion may be a separate body from the housing body portion of the battery housing, and may be fixed to the outer peripheral wall of the housing body portion.

In the lower vehicle-body structure of a vehicle according to the above-mentioned aspect, the inner skeleton portion is fixed to the outer peripheral wall of the housing body portion of the battery housing and hence, it is possible to ensure high rigidity of the housing body portion.

In addition, the inner skeleton portion is fixed to the outer peripheral wall of the housing body portion and hence, it is possible to suppress a situation in which the battery cell housed in the battery housing is damaged or the like in a collision of a vehicle.

Further, in the lower vehicle-body structure of a vehicle according to the above-mentioned aspect, the inner skeleton portion is a separate body from the housing body portion and hence, it is possible to define the position of the inner skeleton portion relative to the housing body portion depending on the arrangement of the battery cell in the battery, the shape of the housing body portion, or the like. Therefore, the standardized inner skeleton portion can be fixed to the battery having any of various shapes and hence, it is possible to achieve a reduction in manufacturing costs.

The lower vehicle-body structure of a vehicle according to the above-mentioned respective aspects can both ensure safety when a collision load is input and ensure a high degree of freedom in design relating to arrangement of seats in a vehicle cabin.

### BRIEF DESCRIPTION OF THE DRAWINGS

FIG. 1 is a plan view showing a portion of a vehicle to which a lower vehicle-body structure according to an embodiment of the present disclosure is applied.

FIG. 2 is a developed perspective view showing a battery and battery outer cross members.

FIG. 3 is a plan view showing the configuration of a housing body portion of a battery housing.

FIG. 4 is a plan view showing a structure of fixing inner members of the housing body portion to the battery outer cross members.

FIG. 5 is a cross-sectional view showing a structure of fixing a right member of the housing body portion to a side sill.

FIG. 6 is a plan view showing a structure of fixing the battery outer cross members to seat rails.

FIG. 7 is a cross-sectional view showing the structure of fixing the battery outer cross member to the seat rail.

### DETAILED DESCRIPTION

Hereinafter, an embodiment of the present disclosure will be described with reference to drawings. Modes described hereinafter are merely given as examples of the present disclosure, and the present disclosure is not limited at all to the following modes except for the essential configurations.

In drawings used in the description made hereinafter, “FR” indicates the front side of the vehicle, “RR” indicates the rear side of the vehicle, “LH” indicates the left side of the vehicle, “RH” indicates the right side of the vehicle, “UP” indicates the upper side of the vehicle, and “LO” indicates the lower side of the vehicle.

### 1. Configuration of Vehicle 1

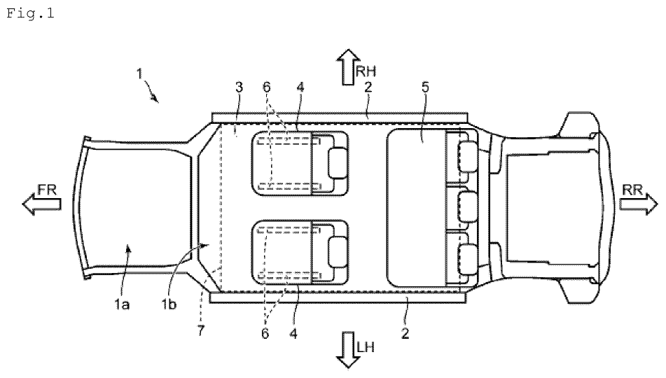

The configuration of a vehicle 1 to which a lower vehicle-body structure according to the present embodiment is applied will be described with reference to FIG. 1. In FIG. 1, the configuration of the vehicle 1 is only partially illustrated, and the illustration of a power train and the like is omitted.

As shown in FIG. 1, the vehicle 1 includes a power train mounting portion 1a at the front portion thereof, and includes a vehicle cabin portion 1b at a location behind the power train mounting portion 1a, the power train being mounted on the power train mounting portion 1a, occupants riding in the vehicle cabin portion 1b. A floor panel 3 is disposed at the lower portion of the vehicle cabin portion 1b. Vehicle seats 4 and 5 are disposed on the floor panel 3. Of the vehicle seats 4 and 5, each front vehicle seat 4 includes seat rails 6 disposed on the floor panel 3. The front vehicle seats 4 are slidable in the front-rear direction within the range in which the seat rails 6 are provided.

Both lateral parts of the floor panel 3 in the vehicle width direction are fixed to side sills 2. Although not particularly illustrated in FIG. 1, a center tunnel may be provided between the left and right vehicle seats 4 disposed on the front side.

A battery 7, which supplies power to the power train, is disposed below the floor panel 3. The vehicle 1 according to the present embodiment is an electric vehicle (BEV), in which a power train includes only a travel-driving motor, or is a hybrid electric vehicle (HEV), in which a power train includes a travel-driving motor and an engine.

### 2. Configurations of Battery 7 and Components Around Battery 7

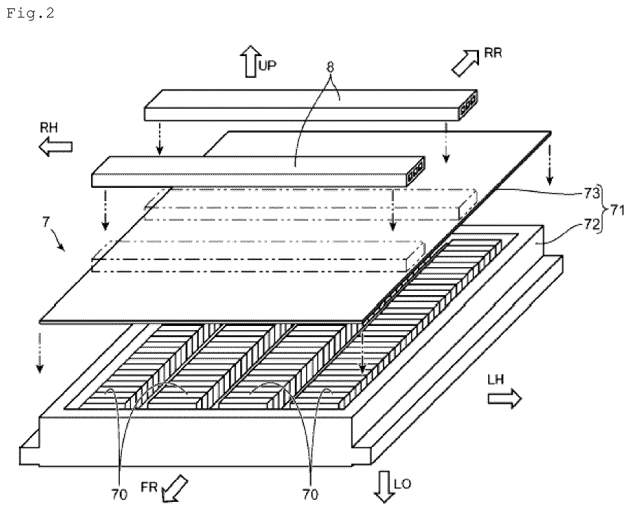

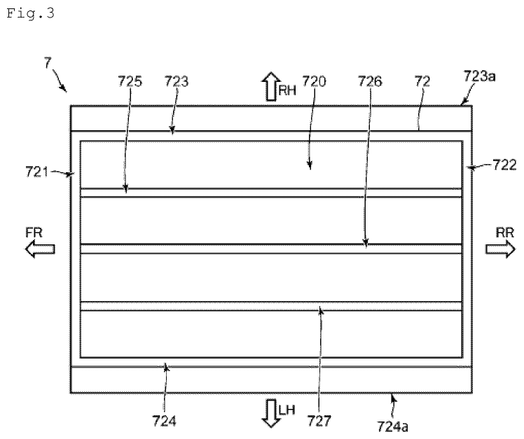

The configuration of the battery 7 disposed below the floor panel 3, and the configurations of components around the battery 7 will be described with reference to FIG. 2 and FIG. 3.

As shown in FIG. 2, the battery 7 includes a plurality of battery cells 70, and a battery housing 71 that accommodates the plurality of battery cells 70, the battery housing 71 having a flat rectangular parallelepiped shape. Each of the plurality of battery cells 70 is a lithium ion battery, a nickel hydrogen battery, or other types of battery. FIG. 2 shows a mode in which each battery cell 70 has a quadrangular exterior. However, the appearance shape of the battery cell 70 is not limited to such a shape, and it is also possible to adopt a battery cell having a cylindrical shape or a laminated exterior (pouch exterior), for example.

The battery housing 71 includes a housing body portion 72 and a lid portion 73, the housing body portion 72 being a casing having an opening on the upper side thereof, the lid portion 73 closing the opening of the housing body portion 72. As shown in FIG. 3, the housing body portion 72 includes members 721 to 724, a plurality of (three in the present embodiment, for example) inner members (inner skeleton portions) 725 to 727, and a bottom panel 720, the members 721 to 724 being outer peripheral walls that constitute a lattice-shaped frame body, the plurality of inner members 725 to 727 being provided to connect the front member 721 with the rear member 722, the bottom panel 720 constituting a bottom portion. As shown in FIG. 2, the plurality of battery cells 70 are accommodated in a space defined by the members 721 to 724 and the inner members 725 to 727.

The inner members 725 to 727 are provided in such a way as to extend in the front-rear direction (second direction) along the members 723 and 724, and are disposed in a spaced-apart manner in the vehicle width direction (first direction). As shown in FIG. 2, the upper surfaces of the inner members 725 to 727 are located at a position lower than the upper surfaces of the members 721 to 724, which constitute the frame body. Due to such a configuration, when the opening of the housing body portion 72 is closed by the lid portion 73, the upper surfaces of the inner members 725 to 727 do not directly come into contact with the lower surface of the lid portion 73.

The lid portion 73 is fixed to the members 721 to 724 and the inner members 725 to 727 in a state of being disposed in such a way as to close the opening of the housing body portion 72.

Two battery outer cross members (outer skeleton portion) 8 are placed on the lid portion 73. The two battery outer cross members 8 are provided in such a way as to extend in the vehicle width direction (first direction), and are disposed in a spaced-apart manner in the front-rear direction (second direction). In the present embodiment, the battery outer cross members 8 are separate bodies from the lid portion 73, and are directly placed on the lid portion 73. That is, the battery outer cross members 8 are disposed between the lid portion 73 and the floor panel 3.

Although the battery outer cross members 8 are constituted as separate bodies from the lid portion 73 in the present embodiment, the battery outer cross members 8 may be integrally formed with the lid portion 73. The inner members 725 to 727 may be fixed by welding or by fastening or the like using bolts to the front member 721 and the rear member 722, of the members 721 to 724 which constitute the frame body. In addition, the inner members 725 to 727 and the members 721 to 724 may be integrally formed.

### 3. Fixing of Battery Outer Cross Members 8 to Inner Members 725 to 727

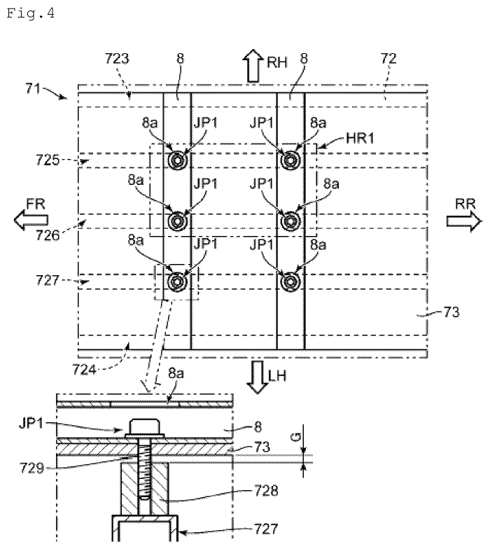

A mode of fixing the battery outer cross members 8 to the inner members 725 to 727 will be described with reference to FIG. 4. FIG. 4 is a plan view showing the battery outer cross members 8 and the inner members 725 to 727 which are fixed to each other with the lid portion 73 interposed between the battery outer cross members 8 and the inner members 725 to 727.

As shown in FIG. 4, the two battery outer cross members 8 are disposed in such a way as to be distant from each other in the front-rear direction. In contrast, the plurality of inner members 725 to 727 are disposed in such a way as to be distant from each other in the vehicle width direction. The battery outer cross members 8 and the inner members 725 to 727 are disposed such that the battery outer cross members 8 are substantially orthogonal to the inner members 725 to 727 when viewed in a plan view.

The battery outer cross members 8 are fixed to the inner members 725 to 727 at intersecting portions between the battery outer cross members 8 and the inner members 725 to 727. Specifically, as shown in a cross section part in FIG. 4, collars 728 are fixed to the upper side of each of the inner members 725 to 727 (only the inner member 727 being illustrated in the cross section part). Each collar 728 has a female screw formed in such a way as to extend downward from the upper end surface of the collar 728. Bolts 729 inserted from opening portions 8a provided at the upper portion of each battery outer cross member 8 are fastened to the female screws of the collars 728. With such fastening, the battery outer cross members 8 are fixed to the inner members 725 to 727 at the intersecting portions between the battery outer cross members 8 and the inner members 725 to 727 (fixed portions JP1).

By fixing the battery outer cross members 8 to the inner members 725 to 727 at the fixed portions JP1 as described above, the battery outer cross members 8 and the inner members 725 to 727 constitute a lattice structure portion (rectangular lattice structure portion) HR1 having a rectangular shape when viewed in a plan view.

As shown in the cross section part in FIG. 4, in the present embodiment, a gap G is formed between the upper surface of the collar 728 and the lower surface of the lid portion 73. Such a configuration is adopted to certainly fix the battery outer cross members 8 to the inner members 725 to 727 by causing a fastening force to act between the battery outer cross members 8 and the inner members 725 to 727 also in the case in which manufacturing errors occur in the inner members 725 to 727, the collar 728, or the like. In addition, such a configuration can prevent the generation of abnormal sound caused by the collar 728 and the lid portion 73 coming into contact with or separating from each other due to the effect of vibrations or the like during traveling of the vehicle 1.

### 4. Arrangement of Battery Housing 71 on Side Sills 2

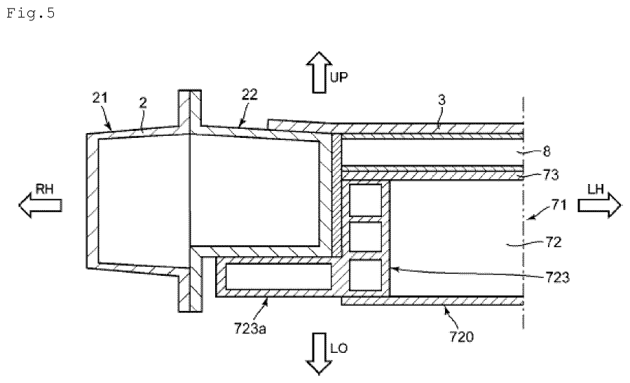

A mode of disposing the battery housing 71 on the side sills 2 will be described with reference to FIG. 5. Although FIG. 5 illustrates the side sill 2 on the right side of the vehicle body, and the right part of the battery housing 71, the same configuration is also adopted for the arrangement of the side sill 2 on the left side of the vehicle body and the left part of the battery housing 71.

As shown in FIG. 5, the end portion of the floor panel 3 in the vehicle width direction is fixed in a state of being placed on the upper surface of the side sill 2. The side sill 2 is constituted by fixing a pair of constituting members 21 and 22 to each other, each of the pair of constituting members 21 and 22 having a hat shape. The floor panel 3 is fixed to the constituting member 22 that constitutes the side sill 2, and that is disposed on the vehicle-width-direction inner side.

Each battery outer cross member 8 is disposed in a state of being interposed between the floor panel 3 and the battery housing 71 in the up-down direction. The end portion of the battery outer cross member 8 in the vehicle width direction is disposed in such a way as to be in contact with or proximate to the inner side surface of the constituting member 22 of the side sill 2.

The housing body portion 72 of the battery housing 71 is also disposed in such a way as to be in contact with or proximate to the constituting member 22 of the side sill 2. Of the outer peripheral walls of the housing body portion 72, each of the left and right members 723 and 724 (see FIG. 3) includes an outwardly-projecting portion 723a that protrudes outward in the vehicle width direction, and that is in contact with or proximate to the lower surface of the constituting member 22 of the side sill 2.

5. Fixing of Seat Rail 6 to Battery Outer Cross Member 8 with Floor Panel 3 Interposed Therebetween

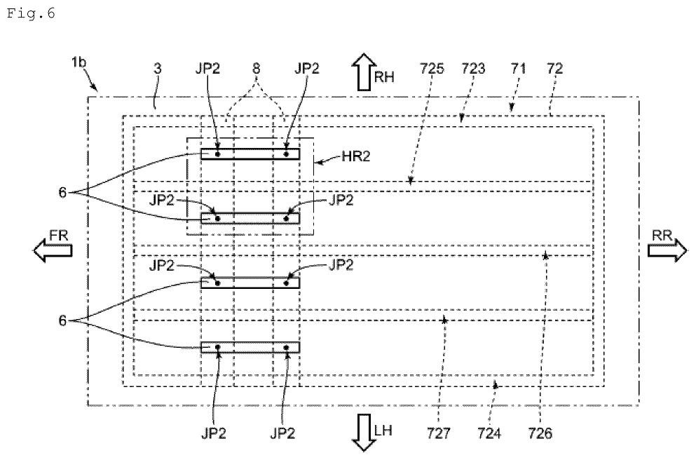

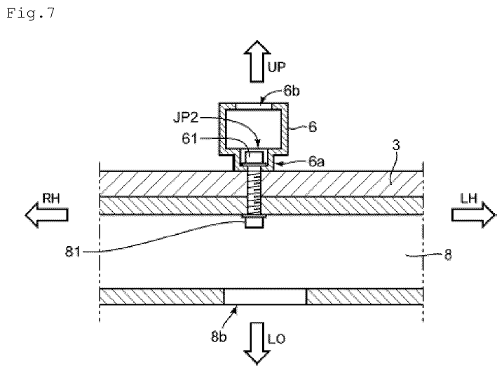

A mode of fixing the seat rails 6 to the battery outer cross members 8 with the floor panel 3 interposed therebetween will be described with reference to FIG. 6 and FIG. 7.

As shown in FIG. 6, the two battery outer cross members 8 are disposed in such a way as to be distant from each other in the front-rear direction. In contrast, four seat rails 6 are disposed in such a way as to be distant from each other in the vehicle width direction. The battery outer cross members 8 and the seat rails 6 are disposed such that the battery outer cross members 8 are substantially orthogonal to the seat rails 6 when viewed in a plan view.

The battery outer cross members 8 are fixed to the seat rails 6 at intersecting portions between the battery outer cross members 8 and the seat rails 6. Specifically, as shown in FIG. 7, each seat rail 6 includes a projecting portion 6a protruding downward, and is fixed to the battery outer cross member 8 by bolts 61 each of which penetrates through the floor panel 3 from the inner side of the projecting portion 6a, and then reaches the battery outer cross member 8. Each bolt 61 is inserted from an opening portion 6b provided at the upper portion of the seat rail 6, and is threadedly engaged with a nut 81 inserted from an opening portion 8b provided at the lower portion of the battery outer cross member 8. With such engagement, the battery outer cross members 8 are fixed to the seat rails 6 at the intersecting portions between the battery outer cross members 8 and the seat rails 6 (fixed portions JP2).

In the present embodiment, although the respective seat rails 6 are disposed between the members 721 to 724 and the inner members 725 to 727 of the housing body portion 72 in the vehicle width direction, the arrangement of the seat rails 6 is determined by the arrangement of the vehicle seats 4 in the vehicle cabin portion 1b. Therefore, the respective seat rails 6 are not always disposed between the members 721 to 724 and the inner members 725 to 727 in the vehicle width direction.

By fixing the battery outer cross members 8 to the seat rails 6 at the fixed portions JP2 as described above, the battery outer cross members 8 and the seat rails 6 constitute a lattice structure portion (rectangular lattice structure portion) HR2 having a rectangular shape when viewed in a plan view.

### 6. Advantageous Effect

In the vehicle 1 to which the lower vehicle-body structure according to the present embodiment is applied, the battery outer cross members (outer skeleton portions) 8 is disposed between the floor panel 3 and the battery housing 71, that is, below the floor panel 3. Accordingly, also in a case in which the height of the battery outer cross member 8 in cross section is defined in order to ensure rigidity of the vehicle body, there is no possibility of affecting the height position of the seat rails 6 (the height position of the vehicle seats 4) with respect to the floor panel 3.

In the vehicle 1, the seat rails 6 are fixed to the inner members 725 to 727 of the battery housing 71 via the battery outer cross members 8. In the vehicle 1, the seat rails 6 are fixed to the inner members 725 to 727 of the battery housing 71 and hence, undesired vibrations or the like of the vehicle seats 4 can be prevented. Therefore, it is possible to achieve excellent riding comfort of the vehicle seats 4.

In the present embodiment, the battery outer cross members 8 are separate bodies from the lid portion 73 of the battery housing 71. However, the battery outer cross members 8 may be integrally formed with the lid portion 73. In addition, in the present embodiment, the inner members (inner skeleton portions) 725 to 727 are formed as separate bodies from the housing body portion 72, and are fixed to each other. However, the inner members 725 to 727 may be integrally formed with the housing body portion 72.

The vehicle 1 to which the lower vehicle-body structure according to the present embodiment is applied includes the two battery outer cross members (the first outer skeleton portion and the second outer skeleton portion) 8 as the outer skeleton portions. The three inner members (including the first inner skeleton portion and the second inner skeleton portion) 725 to 727 are fixed to the two battery outer cross members 8. The two battery outer cross members 8 are disposed in such a way as to be spaced apart from each other in the front-rear direction (second direction), and the three inner members 725 to 727 are disposed in such a way as to be spaced apart from each other in the vehicle width direction (first direction). Due to such a configuration, in the vehicle 1, the two battery outer cross members 8 and the three inner members 725 to 727 of the battery housing 71 constitute the rectangular lattice structure portion HR1 (see FIG. 4) when viewed in a plan view from one direction along the up-down direction. Therefore, high rigidity can be ensured under the floor panel 3 and hence, it is possible to ensure high safety in a collision (in a front collision, in a side collision) of a vehicle.

In addition, the seat rails 6 are fixed to the two battery outer cross members 8. This means that the seat rails 6 are fixed to the above-mentioned rectangular lattice structure portion HR1 having high rigidity. Therefore, in the vehicle 1, undesired vibrations or the like of the vehicle seats 4 are prevented and hence, it is possible to achieve excellent riding comfort of the vehicle seats 4.

In the vehicle 1 to which the lower vehicle-body structure according to the present embodiment is applied, the two battery outer cross members 8 are directly placed on the lid portion 73 of the battery housing 71 and hence, a load input to the battery outer cross members 8 in a collision or the like of the vehicle is dispersed to the lid portion 73, which extends in directions intersecting with the vehicle up-down direction. Therefore, the vehicle 1 has an advantage in ensuring even higher rigidity of the vehicle body.

In the vehicle 1, the battery outer cross members 8 are provided as separate bodies from the lid portion 73 and hence, it is possible to define the position of the battery outer cross members 8 relative to the lid portion 73 depending on the layout of the vehicle 1. Therefore, the lid portion 73 and the battery outer cross members 8 can be used in common for a plurality of vehicle types and hence, it is possible to achieve a reduction in manufacturing costs.

In the vehicle 1 to which the lower vehicle-body structure according to the present embodiment is applied, the seat rails 6 are directly placed on the floor panel 3. This means that the floor panel 3 is directly interposed between the seat rails 6 and the battery outer cross members 8. Therefore, the floor panel 3 is fixed to the battery outer cross members 8 and the inner members 725 to 727 which are fixed to each other and hence, membrane vibration of the floor panel 3 is suppressed.

In the vehicle 1 to which the lower vehicle-body structure according to the present embodiment is applied, the battery outer cross members 8 are formed to extend in the vehicle width direction, and the inner members 725 to 727 are formed to extend in the front-rear direction and hence, in a side collision, the battery outer cross members 8, in cooperation with the inner members 725 to 727, can resist against a collision load input to the battery outer cross members 8 and, in a front collision, the inner members 725 to 727, in cooperation with the battery outer cross members 8, can resist against a collision load input to the inner members 725 to 727. Therefore, the vehicle 1 can ensure high safety in both a front collision and a side collision.

In the vehicle 1 to which the lower vehicle-body structure according to the present embodiment is applied, the left and right members (outer peripheral walls) 723 and 724 of the housing body portion 72 of the battery housing 71 are disposed in such a way as to be in contact with or proximate to the side sills 2 and hence, a collision load input to the side sill 2 in a side collision is dispersed to the inner members 725 to 727 and the battery outer cross members 8 via the members 721 to 724, which constitute the outer peripheral walls of the battery housing 71. Therefore, the vehicle 1 has an advantage in ensuring high safety in a side collision.

In the vehicle 1 to which the lower vehicle-body structure according to the present embodiment is applied, each of the left and right members (outer peripheral walls) 723 and 724 of the housing body portion 72 of the battery housing 71 includes the outwardly-projecting portion 723a, and the outwardly-projecting portion 723a is disposed in such a way as to be in contact with or proximate to the lower surface of the side sill 2 and hence, it is possible to suppress vertical movement of the battery 7 during traveling or other movement of the vehicle. In the vehicle 1, the vertical movement of the battery 7 can be suppressed during traveling or other movement of the vehicle and hence, it is possible to suppress membrane vibration of the floor panel 3 which is fixed to the battery housing 71 via the battery outer cross members 8. Accordingly, the vehicle 1 can suppress vibrations in the vehicle cabin portion 1b, thus ensuring high comfort of the occupant.

In the vehicle 1 to which the lower vehicle-body structure according to the present embodiment is applied, the inner members 725 to 727 are fixed to the front and rear members (outer peripheral walls) 721 and 722 of the housing body portion 72 of the battery housing 71 and hence, it is possible to ensure high rigidity of the housing body portion 72.

In addition, the inner members 725 to 727 are fixed to the front and rear members 721 and 722 of the housing body portion 72 and hence, it is possible to suppress a situation in which the battery cells 70 housed in the battery housing 71 are damaged or the like in a collision of a vehicle.

Further, in the vehicle 1, the inner members 725 to 727 are constituted as separate bodies from the housing body portion 72 and hence, it is possible to define the positions of the inner members 725 to 727 relative to the housing body portion 72 depending on the arrangement of the battery cells 70 in the battery 7, the shape of the housing body portion 72, or the like. Therefore, the standardized inner members 725 to 727 can be fixed to the battery 7 having any of various shapes and hence, it is possible to achieve a reduction in manufacturing costs.

As has been described above, the vehicle 1 to which the lower vehicle-body structure according to the present embodiment is applied can both ensure safety when a collision load is input and ensure a high degree of freedom in design relating to arrangement of the vehicle seats 4 in the vehicle cabin portion 1b.

### Modifications

In the above-mentioned embodiment, the battery outer cross members 8 are provided as separate bodies from the lid portion 73 of the battery housing 71. However, the present embodiment may also adopt a configuration in which the outer skeleton portions are integrally formed with the lid portion of the battery housing.

In the above-mentioned embodiment, the inner members 725 to 727 are fixed to the front and rear members 721 and 722 of the housing body portion 72. However, in the present embodiment, it is not always necessary to fix the inner skeleton portions to the outer peripheral walls of the housing body portion. Provided that a load can be transmitted, the inner skeleton portions may be in contact with or proximate to the outer peripheral walls of the housing body portion.

In the above-mentioned embodiment, of the front and rear vehicle seats 4 and 5, each of the front vehicle seats 4 includes the seat rails 6, and is slidable in the front-rear direction. However, the present embodiment may also have a configuration in which the rear vehicle seat includes seat rails, and is slidable in the front-rear direction. In such a case, by also fixing the seat rails included in the rear vehicle seat to the outer skeleton portions, it is possible to obtain advantageous effects substantially equal to the above-mentioned advantageous effects.

In the above-mentioned embodiment, the two battery outer cross members 8 and the three inner members 725 to 727 are provided. However, in the present embodiment, it is sufficient that at least one outer skeleton portion and at least one inner skeleton portion be provided.

In the above-mentioned embodiment, each of the rectangular lattice structure portion HR1 and the rectangular lattice structure portion HR2 has a rectangular shape or a square shape when viewed in a plan view. However, in the present embodiment, these rectangular lattice structure portions may have a diamond shape, a parallelogram shape, or other shapes when viewed in a plan view. These rectangular lattice structure portions may also have a trapezoidal shape.

In the above-mentioned embodiment, the configuration is adopted in which the battery outer cross members 8 extend in the vehicle width direction, and the inner members 725 to 727 extend in the front-rear direction. However, the present embodiment may also adopt a configuration in which the outer skeleton portions extend in the front-rear direction, and the inner skeleton portions extend in the vehicle width direction.

In the above-mentioned embodiment, each of the left and right members 723 and 724 of the housing body portion 72 includes the outwardly-projecting portion 723a. However, in the present embodiment, it is not always necessary for the housing body portion to include the outwardly-projecting portion.

In the above-mentioned embodiment, although a material for constituting the battery outer cross members 8 or the inner members 725 to 727 is not particularly mentioned, any material can be adopted provided that the material can be used as a skeleton member of a vehicle. For example, a metal material, such as a steel material or an aluminum alloy, or a resin material, such as a carbon fiber reinforced resin, may be used.

What is claimed is:

1. A lower vehicle-body structure of a vehicle, the lower vehicle-body structure comprising:
a floor panel that constitutes a floor of a vehicle cabin of the vehicle;
a vehicle seat that includes a seat rail disposed on the floor panel;
an outer skeleton portion that is formed to extend in a first direction, and that is disposed below the floor panel, the first direction being either one of a front-rear direction of the vehicle or a vehicle width direction; and
a battery that includes a battery cell and a battery housing accommodating the battery cell, and that is disposed below the outer skeleton portion, wherein
the battery housing includes a housing body portion, a lid portion, and an inner skeleton portion, the housing body portion being a casing that includes an outer peripheral wall and that has an opening on an upper side of the casing, the lid portion closing the opening of the housing body portion, the inner skeleton portion extending in a second direction in the housing body portion to connect opposing portions of the outer peripheral wall, the second direction intersecting with both an up-down direction of the vehicle and the first direction, and
the outer skeleton portion is fixed to the inner skeleton portion with the lid portion interposed between the outer skeleton portion and the inner skeleton portion, and is fixed to the seat rail with the floor panel interposed between the outer skeleton portion and the seat rail.

2. The lower vehicle-body structure of a vehicle according to claim 1, wherein the outer skeleton portion is a first outer skeleton portion and the inner skeleton portion is a first inner skeleton portion, the lower vehicle-body structure further comprising
a second outer skeleton portion disposed between the floor panel and the battery housing, and that is different from the first outer skeleton portion, the second outer skeleton portion extending in the first direction, and being disposed at a distance from the first outer skeleton portion in the second direction, wherein
the battery housing further includes a second inner skeleton portion disposed in the housing body portion, that extends in the second direction, is distant from the first inner skeleton portion in the first direction, and connects the opposing portions of the outer peripheral wall of the housing body portion,
the second inner skeleton portion is fixed to the first outer skeleton portion and the second outer skeleton portion with the lid portion interposed between the second inner skeleton portion and the first outer skeleton portion, and with the lid portion interposed between the second inner skeleton portion and the second outer skeleton portion, and
the second outer skeleton portion is fixed to the first inner skeleton portion with the lid portion interposed between the second outer skeleton portion and the first inner skeleton portion, and is fixed to the seat rail with the floor panel interposed between the second outer skeleton portion and the seat rail.

3. The lower vehicle-body structure of a vehicle according to claim 1, wherein
the outer skeleton portion is a separate body from the lid portion of the battery housing, and is directly placed on the lid portion.

4. The lower vehicle-body structure of a vehicle according to claim 1, wherein
the seat rail is directly placed on the floor panel.

5. The lower vehicle-body structure of a vehicle according to claim 4, wherein
the first direction is the vehicle width direction, and
the second direction is the front-rear direction.

6. The lower vehicle-body structure of a vehicle according to claim 1, wherein
the outer peripheral wall of the housing body portion is in contact with or proximate to side sills in the first direction, the side sills being disposed at opposing sides in the vehicle width direction.

7. The lower vehicle-body structure of a vehicle according to claim 6, wherein
the outer peripheral wall includes an outwardly-projecting portion that is in contact with or proximate to a lower surface of the side sill.

8. The lower vehicle-body structure of a vehicle according to claim 4, wherein
the inner skeleton portion is a separate body from the housing body portion of the battery housing, and is fixed to the outer peripheral wall of the housing body portion.

9. The lower vehicle-body structure of a vehicle according to claim 1, wherein
the first direction is the vehicle width direction, and
the second direction is the front-rear direction.

10. The lower vehicle-body structure of a vehicle according to claim 2, wherein
the first direction is the vehicle width direction, and
the second direction is the front-rear direction.

11. The lower vehicle-body structure of a vehicle according to claim 3, wherein
the first direction is the vehicle width direction, and
the second direction is the front-rear direction.

12. The lower vehicle-body structure of a vehicle according to claim 9, wherein
the outer peripheral wall of the housing body portion is in contact with or proximate to side sills in the first direction, the side sills being disposed at opposing sides in the vehicle width direction.

13. The lower vehicle-body structure of a vehicle according to claim 10, wherein
the outer peripheral wall of the housing body portion is in contact with or proximate to side sills in the first direction, the side sills being disposed at opposing sides in the vehicle width direction.

14. The lower vehicle-body structure of a vehicle according to claim 11, wherein
the outer peripheral wall of the housing body portion is in contact with or proximate to side sills in the first direction, the side sills being disposed at opposing sides in the vehicle width direction.

15. The lower vehicle-body structure of a vehicle according to claim 1, wherein
the inner skeleton portion is a separate body from the housing body portion of the battery housing, and is fixed to the outer peripheral wall of the housing body portion.

16. The lower vehicle-body structure of a vehicle according to claim 2, wherein
the inner skeleton portion is a separate body from the housing body portion of the battery housing, and is fixed to the outer peripheral wall of the housing body portion.

17. The lower vehicle-body structure of a vehicle according to claim 3, wherein
the inner skeleton portion is a separate body from the housing body portion of the battery housing, and is fixed to the outer peripheral wall of the housing body portion.
